(19) United States
(12) Patent Application Publication
(10) Pub. No.: US 2011/0049215 A1
(43) Pub. Date: Mar. 3, 2011

(54) UNPOWERED COIL NAILER

(76) Inventors: Ronald McAfee, Barrie (CA); Vaclav Morkus, Barrie (CA)

(21) Appl. No.: 12/862,918

(22) Filed: Aug. 25, 2010

Related U.S. Application Data
(60) Provisional application No. 61/236,923, filed on Aug. 26, 2009.

(51) Int. Cl. B25C 1/02

(52) U.S. Cl. 227/137; 227/147

(57) ABSTRACT

A nailer carries a supply of coil nails, such as commonly used by roofers, and is swung by hand like a hammer. Each swing drives out a nail, and advances another nail ready to be driven.

### BACKGROUND OF THE INVENTION

1. Field of the Invention

The invention relates to a device for driving nails that are supplied in the form of a coil of connected nails, and more particularly to such a device that uses no external power and is operated by being swung by the user to impart kinetic energy to a nail.

2. Description of the Related Art

The simplest device for driving a nail is a hammer. A basic hammer requires positioning of a nail with one hand and striking the nail with the hammer held in the other hand. More complex hammers have means for holding the nail to the hammer while the hammer is swung, but they have never been popular with tradesmen. Other means for holding the nail so it is ready to be struck by a hammer have been devised, but again they are not popular. Most tradesmen who drive many nails in a day, such as roofers, prefer to use a powered nail gun. The word gun is appropriate because most versions have a trigger to activate the driving of each nail, one at a time. Nail guns may be driven by compressed air, electromagnetism, small explosions of flammable gases such as propane or butane, or a gunpowder charge. Air-powered nail guns are the most popular.

Air-powered nail guns break down frequently because of the need for high air pressure to operate them. Air compressors are expensive to buy and require electric or gas motors to operate which of course use power. The air hose to the air-powered nail gun limits the distance the nail gun can be operated from the compressor. Air-powered nail guns become less reliable in extreme cold, as do flammable gas nail guns and battery-powered electromagnetic nail guns. Electromagnetic nail guns using electric power from the domestic distribution system have the inconvenience of a long power cord, similar to the problems caused by the air hose to an air-powered nail gun. Battery-powered nail guns are known, but have the inconvenience of short battery life, affected by extreme temperatures, and have not become popular with roofers.

Gunpowder nail guns are expensive for each shot, tedious to reload, and are generally reserved for nailing into hard surfaces such as concrete or steel. Some may have a self-loading action for the explosive caps, but require nails to be loaded by hand. Others require hand loading of each cap and each nail.

Because air-powered nail guns use high air pressure, a breakdown of the safety mechanism has caused nails to be ejected by accident causing injury. Failed couplings can eject at high pressure and are a danger as well. In the United States, about 37,000 people every year go to emergency rooms with injuries from nail guns, according to the U.S. Centers for Disease Control. The unpowered coil nailer of the present invention is accident proof in those regards.

Because of the pull from the air hoses, air-powered nail guns often fall from roofs creating a danger to those below and causing damage to equipment or the nail gun itself. Also because of the hoses and large size of air-powered nail guns, they must be carried by hand to transport them, and must be laid on a roof or jack planks when not used. Because the unpowered coil nailer of the present invention is smaller and has no air hose or electric cord, it can conveniently be carried on a hook from a belt or in a holster. For a roofer, that gives more freedom of movement on steeper pitch roofs or sidewalls, as well as moving around a job in general, and therefore is a safer tool.

Powered nailers usually do not use individual nails. Instead, the nails are mounted side-by-side and interconnected. The interconnected nails may be in long strips, similar to a stick of staples, in which case the nails may have clipped heads so the nails can be placed closer together, which facilitates binding them together with some form of glue. In another form, the nails are connected side-by-side with interconnecting filaments of wire or plastic or paper. Roofing nails require a large head which is unsuitable for stacking like staples, so are interconnected with filaments. The assembly of nails interconnected by filaments can usually be rolled into a coil, and the nailer comprises a carrier to hold the coil of nails and feed them one at a time to the position from which each will be driven from the nailer into the target surface. Nail guns vary in the length and the gauge (thickness) of nails they can drive. Small nail guns, often called brad nailers, drive nails with no head. Finish nailers drive smaller gauge nails, over a wide range of lengths, with very small heads. Strap nailers drive 1.5″ to 2.5″ nails for metal connectors used to increase structural strength on wood framed buildings. Framing nailers typically drive 2.5″ to 3.5″ nails. Roofing nailers, which are almost always coil-loaded, drive large headed nails because the large head decreases the risk of the nail tearing through the material being secured, and does a better job of holding shingles to a roof. A typical length is 1.25 inch.

The present invention is essentially a hammer that carries a supply of nails. There are hammers well known in the trade that hold a single nail, usually by magnetism. The user must set each nail in place on the hammer head, and then swing the hammer The present invention automatically positions the nail ready to receive the hammer blow that forces it into the roof.

There is the Magazine Hammer of Schar disclosed in U.S. Pat. No. 4,796,495 that looks much like an ordinary hammer and contains nails in the handle, but those are not coil nails. The same inventor, Schar, invented Nailing Tool disclosed in U.S. Pat. No. 4,340,101.

There is Hammer with Magazine Nail Feed disclosed in U.S. Pat. No. 4,434,929 to Keener. It looks somewhat like an ordinary hammer with a flat magazine holding a stick of nails behind the hammer head, projecting up and backward at about 45 degrees from the hammer head.

These do not make use of the coils of nails that are currently very common and widely used in certain fields within the construction trades, especially roofing. Coils of nails per se are disclosed in U.S. Pat. No. 6,557,703 to Leitner.

### SUMMARY OF THE INVENTION

The present invention is especially well-suited for roofing, because that is a use where the elimination of air hoses and electric wires is especially desirable. The type of nails that come in coils is typical of roofing nails. As used herein, a coil of nails means nails interconnected by wires. The invention and its use will be described here in terms of nailing onto a roof, with the understanding that the invention is not limited to use on roofs. The description of motions will be in terms of up and down, as if the roof is horizontal and the nail is driven vertically, with the understanding that the nailer can be used in any orientation.

The present invention, often called a “nailer” because its function is to drive nails, will be described in its typical orientation, so words like “top” and “front” can be used. The hammer head is at the front of the nailer, and the tip or hammering face of the hammer head that contacts the nail will be at the bottom of the nailer. The words “left” and “right” are as viewed looking at the hammer from its front end, looking past the hammer head. Nails in the coil of nails “advance” when they move towards the hammer head.

The unpowered nailer of the present invention is operated by being swung like a hammer, but contains a coil of nails like a powered nail gun. It works mechanically. It is safe because it contains no explosive material or air pressure. It is convenient because it needs no compressor or air hose or electric cord. It is economical because it does not consume any power. Penetration of the nail is controlled by the force of the swing, eliminating the need to adjust air pressure.

The nailer drives the nail by using the momentum of being swung by the user. Upon loading the coil of nails, the first nail will be placed by hand into the driving position. In that position, the head of the nail is in contact with, or nearly in contact with, a mass of metal that is effectively a hammer head. The hammer head is rigidly fastened to a handle, which in the preferred embodiment is not straight but has the grip part of the handle offset from the part of the handle that is attached to the hammer head. A container, called here a “canister”, containing a coil of nails fills most of the space left by the offset of the handle. The offset allows the centre of mass that is being swung to be approximately in line with the handle, as in an ordinary hammer, so the user experiences the normal feeling of swinging a hammer.

The handle and hammer head are functionally equivalent to a common hammer. The user operates the hammer like a common hammer, except that there is no need to aim the hammer at a nail because a nail is in position to be driven by the hammer head, and moves with the hammer head during the user's swing of the hammer.

The leading edge of the nailer below the hammer head, which can be called a feed body, has means for holding the nail in a nail gate until the tip of the nail has reached the roof and started to enter the roof, whereupon the gate opens and the nail is free to be driven by the hammer head into the roof. The feed body is so called because the nails are fed from the canister through the feed body to the front of the feed body where they are held in place by a pair of nail gates. When the feed body contacts the roof, the feed body will stop moving, because the roof exerts sufficient force to stop it. The feed body has sometimes been called the “touch probe”, because it is the part that first touches the roof and initiates the cycle of driving a nail and feeding a next nail before returning to rest position. The feed body is constructed so it is free to move up in relation to the hammer head, carrying with it the canister of nails. The momentum of the hammer head continues until the hammer head stops upon coming in contact with the roof, at which stage the nail is fully in the roof. When the head of the nail reaches the roof, the nail will stop, and at the same moment the tip of the hammer head has reached the roof so the nailer as a whole will stop, and possibly rebound a little distance from the roof. Broadly, the nailing cycle is: nailer is swung by hand, feed body contacts roof and stops moving (often described as rising, relative to hammer head), linkages cause the nail guide to cease holding nail, hammer face drives nail, nailer stops or rebounds when nail is fully driven, linkages return to rest position closing the nail guide, and movement of linkages towards rest position advances the next nail.

During the interval when the hammer head continues to move and the feed body is stopped on the roof, the feed body and the canister are free to move relative to the hammer head because they are supported by a system of hinged support arms. The movement of the canister and arms can conveniently be described as “rising”, which it does relative to the hammer head although in fact the canister stays resting on the roof and the hammer head moves relative to the canister. If the hammer head was not already in contact with the head of the nail, it very soon advances to make that contact. The first small amount of rising of the support arm system releases a latch that had been holding a pair of feeder arms to the hammer head. The feeder arms are then pulled away from the hammer head because they are pulled by a toggle arm that is connected to the dogleg-shaped support arm. The toggle arm is connected to the dogleg-shaped support arm at the bend of the dogleg, so rotation of the dogleg-shaped support arm involves rearward movement at that connection point. The rearward movement of the feeder arms causes the nail gates to open because the feeder arm on each side of the nailer is linked to the nail gate on that side of the nailer. The hammer head and nail continue to move in contact while losing velocity because of the resistance to penetration of the nail. The nail must move at least its own length, typically 1.25 inch, to be fully driven into the roof. The feed body and canister move by that amount to get out of the way and allow the hammer head to drive the nail. The toggle arms that have pulled the feeder arms are made to bend in the middle and effectively maintain a shortened distance between their end points, so that the feeder arm remains pulled back, until the nailing cycle is nearly finished and the toggle aims are released, allowed to straighten, and that allows the feeder arms, which are being pulled by a spring, to return to their rest position.

Hammer heads used in roofing and home construction range in weight mainly between 16 and 28 ounces. The kinetic energy available for driving the nail is E=M*V²/2. M is the mass of the hammer head, plus the mass of the gate holding the nail to be driven and of the nail itself, plus a small contribution of weight from the handle. V is the linear velocity of the hammer head just before it begins to drive the nail. Most of that energy goes into driving the nail into the roof, although some is lost to resistance in the system of arms and joints and some is lost to slightly deforming and also heating the roof where the feed body makes contact. The mass of the canister, nails, and arms does not contribute to driving the nail, because it is free to move independently of the hammer head and does not bear upon the nail. However, that mass just mentioned does contribute to the heft of the tool as a whole, and it is desirable to minimize that for the comfort of the user. Therefore, there must be a compromise: sufficient weight is needed in the hammer head, but the overall weight should be kept down, so the components other than the hammer head should be as light as possible. In a prototype of the present invention, the head weighed only about 12 ounces, so the user must swing the nailer a little faster than an ordinary hammer. As will be seen in the drawings, most of the large parts of the nailer have been made lighter by holes in them, or channels cut into them. To the extent that the weight of the hammer head is kept down, the necessary velocity provided by the user will have to be greater, so that the kinetic energy is sufficient to drive the nail. Fortunately, the kinetic energy increases as the square of the velocity, so a small increment in V makes up for a shortfall in M. Just as, ordinary hammers are available with a range of head weights, the present invention could be offered with a range of weights of the hammer head to suit the preferences of various users. It is a fundamental characteristic of the nailer that only one blow is available to drive each nail, because at the end of a blow, the next nail automatically advances into position to be driven. The same is true of powered nailers, and for that reason roofers generally carry a hammer, or hatchet that includes a hammer head, to finish driving in any nails that have not penetrated as far as needed.

The velocity V is a linear velocity at the moment of contact with the roof, and is created by the user swinging the nailer though an arc, so the direction of velocity is tangential to the arc, which the user will attempt to make perpendicular to the roof. The longer the radius of the arc, the greater is the tangential velocity for any given movement of the user's arm. Therefore, the longer the handle of the nailer, the easier it is to have a large velocity V. However, a handle too long will be inconvenient to use and lead to less accurate swings. A compromise must be chosen. A short handle may appeal to a user who is able to swing very fast, while a longer handle may appeal to a user who has less strength but achieves accuracy through practice.

The swing gives sufficient energy to operate three other functions of the nailer. First, some energy is used to open the gate holding the nail so the nail is free to emerge from the nailer. Second, some energy is used to cut the wires that hold the nails in the coil. And third, some energy is used to advance the nails in the coil so that a nail is ready for the next swing of the nailer.

After the hammer head finishes driving the nail and begins to rebound from the roof, a new nail must advance into the driving position. While not essential, it is practical for reasons of size of the nailer for the initial position of the hammer head to be close above the head of the nail. Therefore, the new nail cannot advance until the canister has returned to its initial position relative to the hammer head. The initial position may also be called the “rest position” because it is the position of all elements of the nailer when the nailer is not in motion. The energy to advance the nail must be captured and stored while the nailer is still in motion, because that is the only source of energy here, and not released until the canister has returned to its rest position. This delay in advancing the nail is achieved as follows. A two-part toggle arm is hinged in the middle, and hingedly fastened at the end farthest from the hammer head to the lower support arm, while hingedly fastened at the front end to a feeder arm. The feeder arm has several functions, described below. Like most elements of the nailer, there are mirror-image feeder arms, toggle arms, and support arms, on each side of the nailer, but this description will refer only to one side of the nailer. When the canister rises, the lower support arm rotates about its rear hinge point and pulls back on the feeder arm which is linked to it. The feeder arm pushes on the toggle arm, forcing it to bend at the hinge between its two sections. The toggle arm moves from being essentially a straight line to being an inverted letter “V”. On the top of the front section of the toggle arm there is a standoff on which is mounted a roller. When the roller rises as a result of the bending of the toggle are, it contacts the bottom side of a delay flap that pivots and so moves aside as the roller pushes it up. The delay flap is pivotally mounted on the handle. Before the roller has risen as far as it will rise, it runs off the end of the delay flap and is then above the delay flap. The delay flap is therefore released and it falls back under the force of a spring, to its rest position. The roller continues along the top side of the delay flap until it has circumscribed it, which results in the toggle arm remaining bent at its central joint. When the nail has been driven, the hammer head will be lifted from the roof and the canister will be free to move down to its rest position, being pushed down by the support arms. The downward movement will be assisted by gravity, but is assured by a spring that pulls the feeder arm back to its rest position, thereby straightening the toggle arm. That straightening is delayed until the roller has completed circumscribing the delay flap. Just before the canister has moved all the way down to its rest position, the roller will run off the delay flap at its pivoted end, thereby freeing the toggle arm to return to its straight position, aided by a spring. That movement of the feeder arm is used to advance the next nail into position to be driven, and also to close the nail gates so that the advanced nail will be held in position.

The advancing of the nails is brought about by a pair of feeding latches, one connected to each of the pair of feeder arms. The latches push forward one nail in the coil, and are hinged on axes parallel to the long axis of the nail, so they will bend aside to pass the next nail waiting to be advanced and close behind that next nail. When the feeder arm is pulled back and the feeding latches are moving back to grab the next nail, it is desirable to have a pair of keeping latches that prevent any backward movement of the interconnected nails that have already passed that point. These keeping latches do not move back and forth, but are hinged on axes parallel to the nail to partially rotate and so bend aside when the nails move forward, and caused by a torsion spring to snap back and trap the nail when it has advanced far enough.

The assembly of lower support arm, toggle arm, roller, delay flap, and feeder arm are preferably symmetrically duplicated on each side of the nailer. There will be a top support arm that is above the handle and can be a single piece which is connected to the feeder arms on both sides of the nailer. A plane through the long axis of the handle and hammer head is a plane of symmetry in all except minor details.

### BRIEF DESCRIPTION OF THE DRAWINGS

The preferred embodiments of the invention will now be described in detail with reference to the following drawings in which:

FIG. 1 is an overall perspective view of the nailer.

FIG. 2 is a side-on perspective view of the skeleton of the nailer, showing the hammering parts and the nail supply.

FIG. 3 is a perspective view of the hammer head.

FIG. 4 is a perspective view of the canister that holds the coils of nails.

FIG. 5 is a perspective view of the vertical link to which the canister is indirectly attached.

FIG. 6 is a perspective view of the connection between the vertical link and the canister.

FIG. 7 is a side plan cut-away view of the elements that form a flexible parallelogram to support the nail supply and feed mechanism.

FIG. 8 is a close-up perspective right-side view of the lower portion of the nailer.

FIG. 9 is a close-up perspective left-side view of the lower portion of the nailer.

FIG. 10 is a cut-away perspective bottom view showing the nail gate and means for advancing nails.

FIG. 11 is a cut-away perspective side view of the linkage that controls the advancing of nails.

FIG. 12 is a perspective front view of an alternative embodiment of the nail gates.

### DETAILED DESCRIPTION OF THE PREFERRED EMBODIMENT

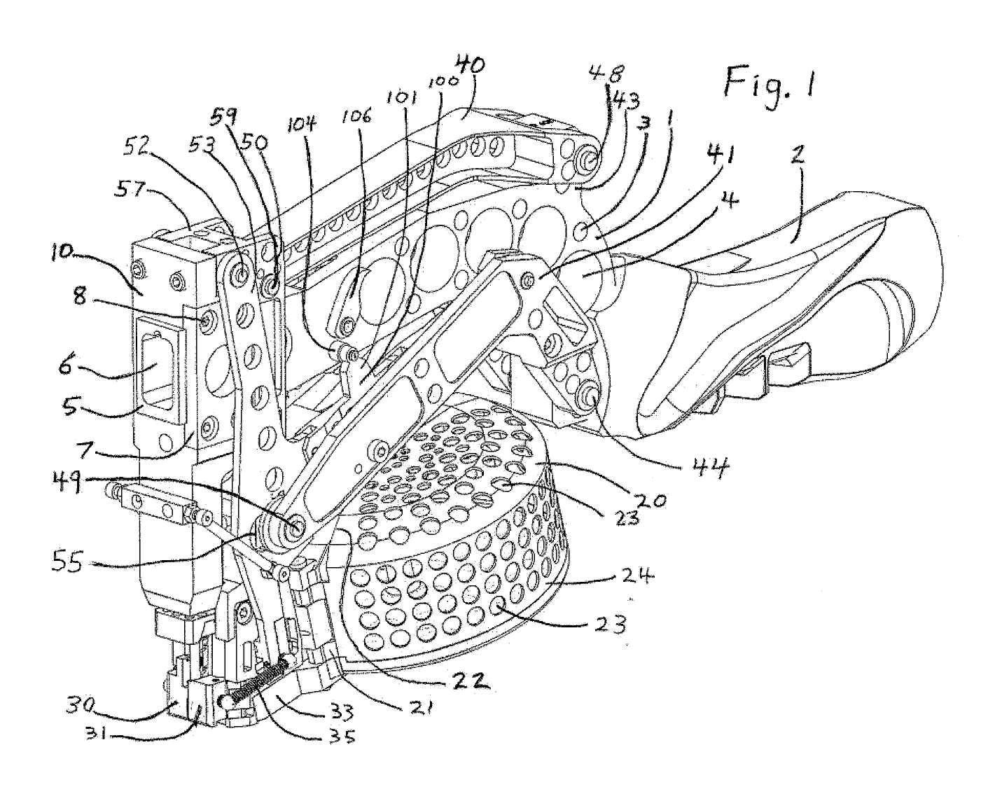

FIG. 1 shows a perspective view of the nailer. The handle 1 is a continuous element of sturdy material suitable for a handle, such as steel, aluminum, magnesium, fibreglass, wood, or carbon fibre. The handle 1 is not straight, but has the back section offset from the front section, for ergonomic purposes, such that the user's hand is positioned relative to the nail that will be driven in approximately the same way as in the case of an ordinary hammer. That causes the user to feel that the hammer blows are more natural, like an ordinary hammer. The handle 1 has a grip 2, typically made of plastic or rubber, which is shown with a design that ergonomically fits the user's hand. However, the invention would work perfectly well if the grip 2 were simply a suitably sized portion of the handle 1, or any other shape adapted to comfortably fit a hand. The grip could take any form that might be found on an ordinary hammer. The handle 1 is optionally made lighter by a number of small holes 3 and large holes 4 passing through it. Other methods of lightening, such as channels carved in the sides of the handle 1, or a hollow handle 1, may be concurrently or alternatively used. The front end 5 of handle 1 contains an optional void 6 for the purpose of lightening the handle. The front end 5 of handle 1 fits in a channel in the nailer head 10 that is open on the left side but that opening is closed, so the handle 1 is held securely by a plate 7 that is fastened to the nailer head 10 by four screws 8.

In FIG. 1, the nailer has a canister 20 adapted to hold a coil of nails. The portion of the canister 20 in the foreground of the picture has a hinge 21 that allows the canister door 24 comprising the near side of the canister 20 to swing away from the rest of the canister 20 at the line 22 (the edge of the door 24), in order to load the canister 20 with a coil of nails. The canister 20 and canister door 24 may be made of metal, plastic, carbon fibre, or any sturdy material. It is important that the canister not add much weight to the nailer, and FIG. 1 shows one means of achieving that, which is a number of holes 23 in the canister door 24 as well as in the whole of the canister 20.

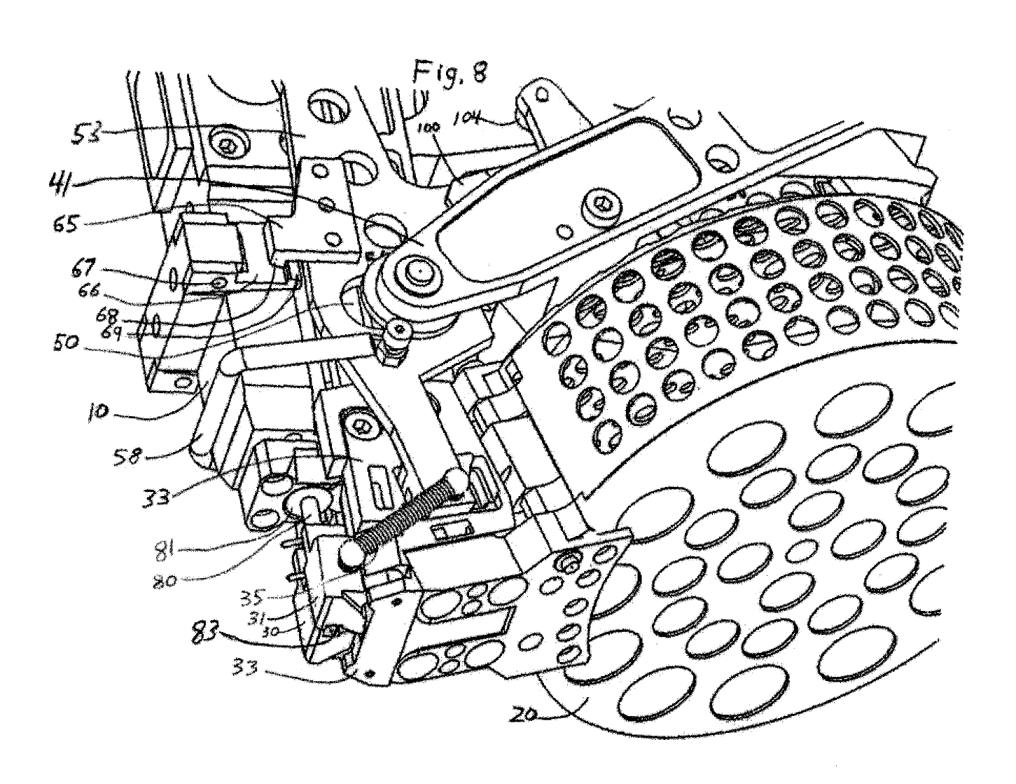

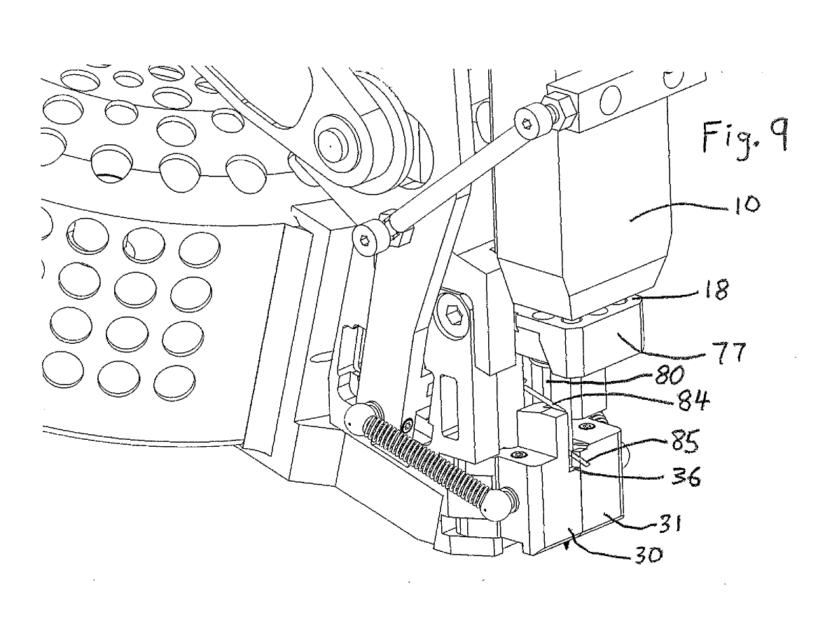

FIG. 1 also shows a roller 104 mounted on a boss 101 that is part of toggle arm 100. In operation, the roller 104 circumscribes the delay flap 106, as will be explained below in connection with FIG. 11. FIG. 1 does not show an optional feature that has been found useful, namely a latch that holds the feeder arm 53 in a rest position close to the hammer head 10 except when the nailer is actively driving a nail. The latch is shown in FIG. 8, and explained below.

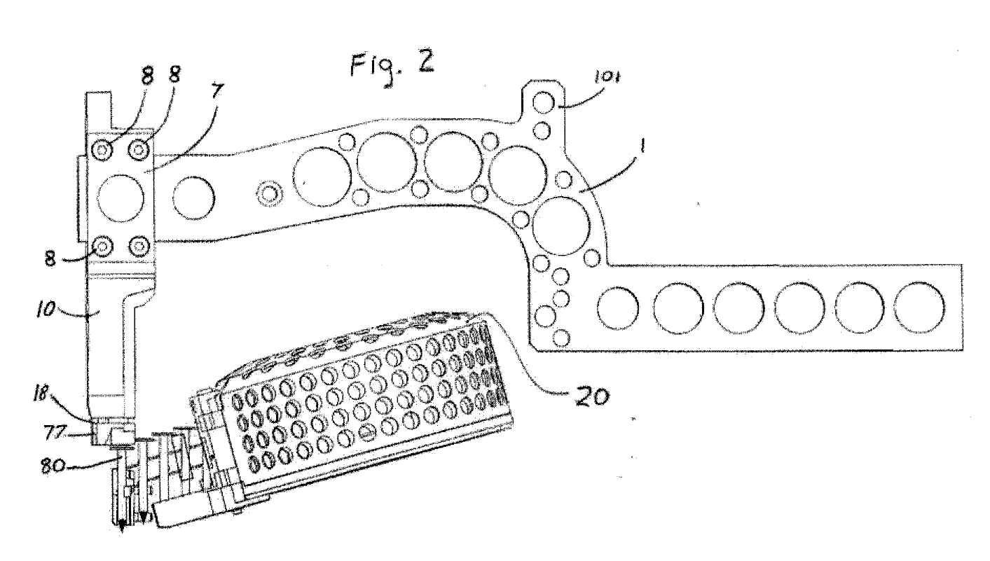

FIG. 2 shows the basic skeleton of the nailer, omitting the system for feeding nails to the ready position. In essence, the nailer is a hammer, having a head and a grip and a handle with an unusual bend in it to provide a space for a container of coil nails. There is a boss 101 for attaching a support arm. FIG. 2 shows the handle 1 which is connected to the hammer head 10 because it is captured by plate 7, which is held by screws 8. Canister 20 holds nails, of which five are partially visible. Ready nail 80 is in position to be driven. Hammer head 10 is extended by touch guide 77 which is below hammer head 10 by a small gap 18. The connection between hammer head 10 and touch guide 77 is spring loaded to cushion some of the shock of the final impact when the nail 80 is fully driven. The special features of the present invention are explained below.

FIG. 2 shows an embodiment that has been found to be ergonomically desirable, but is not a precise requirement of the invention. That is, that the portion of the handle 1 that is to be gripped by the user has an imaginary longitudinal axis that, if extended, passes through the hammer head 10 approximately midway between the top of the hammer head 10 and the tip of the ready nail 80.

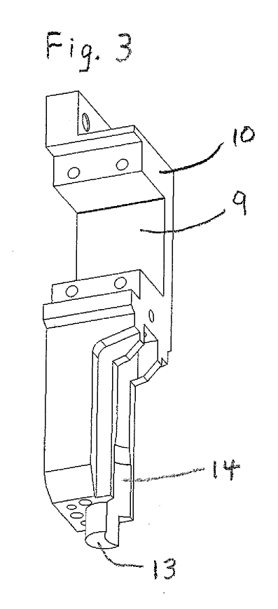

FIG. 3 shows the nailer head 10 with the channel 9 on the side intended to receive the handle. The nailer head 10 is made of a solid piece of sturdy metal, typically steel. The hammer head 10 terminates at the end that drives the nails as a hammer face 13. The hammer face 13 may be treated to make it harder than the rest of the hammer head 10, to resist wear. The hammer face 13 is crescent shaped as viewed from below, because coil nails are arranged with the head of one partly overlapping the head of the nail next along the coil, and the hammer face 13 must strike only one nail at a time. A groove 14 extends the crescent cut-out so that the head of a nail not being driven can pass up the groove 14 as the hammer face pushes the nail being driven out of the nailer. Optionally, the hammer face 13 may be a separate piece that is screwed or otherwise removably connected to the hammer head 10 so as to be replaceable.

Referring again to FIG. 1, the nailer holds a nail in a gate, of which the left nail gate 30 and right nail gate 31 are shown. These nail gates 30, 31 will open as the hammer head 10 drives the nail, so as to release the nail. A gate link 35 returns the right nail gate to the closed position when the nailing cycle is complete, and a similar gate link (not shown) closes the left nail gate. The gate link 35 is illustrated as a compression spring, but alternatively it may be a solid link.

When the nailer is swung to drive a nail, the canister 20 must rise relative to the hammer head to allow the hammer head 10 to descend all the way to the roof to fully drive a nail. More precisely, the canister 20 stops moving and hammer head 10 continues to move, but it is convenient to speak in the frame of reference of the hammer skeleton, where the canister 20 rises relative to the skeleton. The canister 20 is therefore moveable with respect to the hammer head 10 and handle 1. To that end, the canister is supported by three hinged support arms, the upper arm 40, the near-side arm 41, and a far-side arm (not visible in FIG. 1) that is a mirror image of the near-side arm 41. The near-side arm 41 and far-side arm are jointly pivoted about hinge rod 44 that passes through the handle 1. These two arms may be, but are not necessarily, linked together on their bottom sides, in which case they might be made from a single billet. The upper arm 40 is hinged at binge rod 48. It is desirable to make the arms as light as possible while maintaining strength and rigidity, and for that purpose there are depressions cut into the near-side arm 41 and a series of holes through the upper arm 40. The far-side arm has depressions similar to near-side arm 41. Alternatively, the depressions in the near-side arm 41 and far-side arm could be holes passing through. At the front close to the hammer head 10, the near-side arm 41 and far-side arm are joined by a hinge rod 49 which passes through an opening 55 in the right feeder arm 53.

The aims, as well as the handle and canister, are preferably made as light as possible by removal of some material, either by holes right through or by channels milled into their long sides.

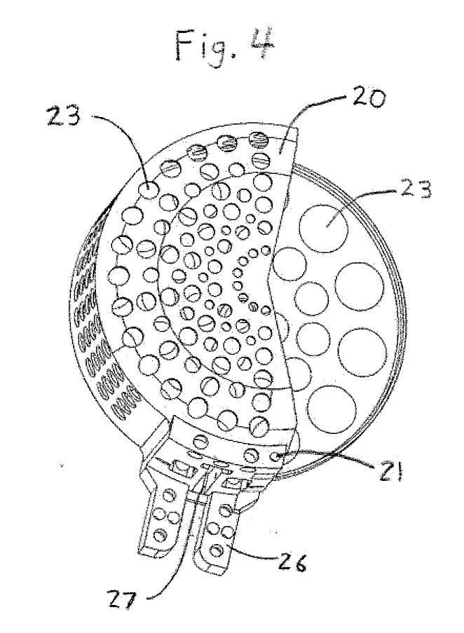

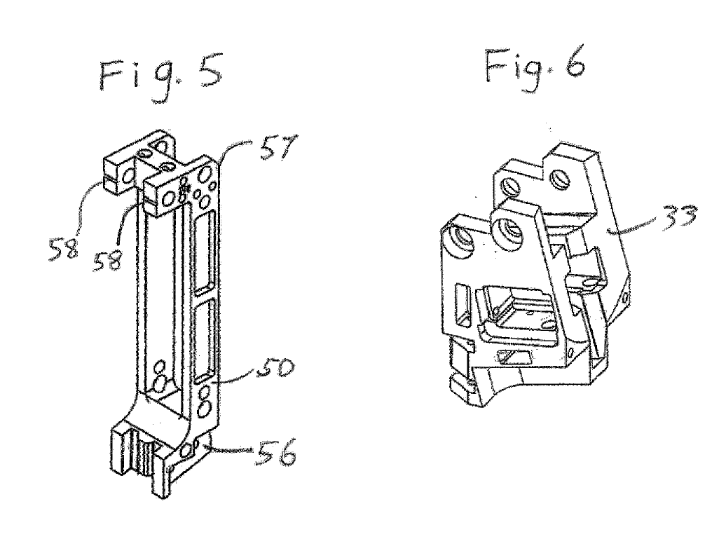

FIG. 4 shows the canister 20 without its door, which would be attached at hinge point 21. All sides of it are perforated with holes 23 to reduce weight, a desirable but not essential element of the present invention. A connecting element 26 serves to join the canister 20 to the vertical link 50 shown in FIG. 5. Connecting element 26 has a T-shaped opening 27 that is approximately the shape of a nail with clearance for the head and shaft of the nail, preferably with chamfered edges on the inside of the canister 20 so that the nails pass through smoothly.

FIG. 5 shows in isolation one of the components that is only partly visible in FIG. 1, namely the vertical link 50. At its top end 57 it is connected to the upper arm. At its bottom end 56 the vertical link 50 is connected by screws to a complexly shaped feed body 33 shown in FIG. 6, which in turn is connected by screws to the canister 20 by the connecting element 26 shown in FIG. 4. Referring back to FIG. 1, the vertical link 50 is connected by hinge rod 49 to the near-side arm 41 and to the far-side arm (not visible), and is connected to the upper arm 40 by hinge rod 59. A groove 60 on the front of the vertical link 50 will align with a spring-loaded cone mounted in the hammer head (not shown) when the vertical link 50 is at its lowest point, which is its rest point in the nailing cycle. That serves as a detent to hold the vertical link 50, and all other moving parts connected to it, stable during periods between nailing or in storage.

As seen in FIG. 1, the upper arm 40 is mounted at the rear by hinge rod 48 that is pivotally connected to a boss 43 on the handle 1. The upper arm 40 is connected at the front by hinge joint 52 to right feeder arm 53, and left feeder arm (not visible). To summarize in other words: there is an imaginary flexible parallelogram (although the physical elements of the top and bottom sides are not straight lines) that is hinged at each corner, having a single upper arm 40 and a pair of lower arms on each side of the handle 1, the near-side arm 41 and a far-side arm.

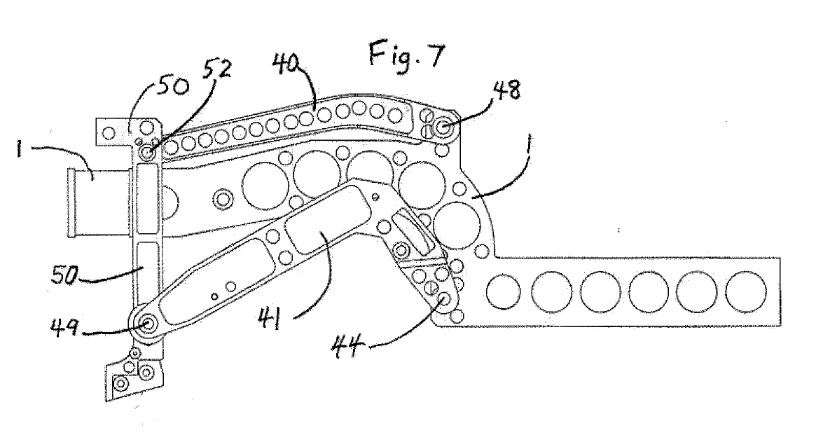

FIG. 7 shows just the elements of the flexible parallelogram, all of which are also visible in FIG. 1 but not as conveniently. The parallelogram is defined by upper arm 40, near-side arm 41 (and the mirror image far-side arm, not shown), vertical link 50, and a portion of the handle 1. Towards the rear, the parallelogram is fastened to handle 1 by hinge rod 44 at the lower rear end of the parallelogram and hinge rod 48 at the upper rear end. The front side of the parallelogram is the vertical link 50, which is free to rise relative to the handle 1, because every corner of the parallelogram is hinged with hinge joints 44, 48, 49, 52. The rear side of the parallelogram is immovable with respect to the handle 1. The geometry of the parallelogram, including the shape of the arms, is chosen so the front side of it, being the vertical link 50, moves essentially parallel to the rear side of the parallelogram. The purpose of the flexible parallelogram is to support the canister and the nail feed mechanism, and to allow them to rise relative to hammer head 10 when they contact the roof. In other words, when the canister contacts the roof it can stop its downward motion while the hammer head 10 can continue downward to drive the nail.

FIG. 8 shows enlarged details of the lower parts of the nailer, where the canister 20 is attached to the elements of the flexible parallelogram referred to above. When the nailer is swung, the first contact with the roof will be by the tip 83 of a nail 80 in the gate. Instantly thereafter, the feed body 33 which is the lowest element of the nailer touches the roof. When the feed body 33 contacts the roof, it is free to rise relative to the hammer head 10 by reason of being held only by the vertical link 50 which in turn is held only by the near-side arm 41 and counterpart far-side arm, and by upper arm (not visible in FIG. 8). The vertical link 50 is the front end of the flexible parallelogram mentioned above, and when the parallelogram changes shape the vertical link 50 causes the feed body connected to it to move. The hammer head 10 will continue to descend, driving the nail, and the canister 20 and associated parts will not interfere with that descent.

Referring again to FIG. 8, when the feed body 33 contacts the roof, the vertical link 50 is pushed up relative to the hammer head 10. The right feeder arm 53 and also the left feeder arm (not visible) are pushed up because they are attached by hinge joint 52 to vertical link 50. Attached to feeder arm 53 is a latch catch 65 that engages latch flap 66 attached to hammer head 10. A latch catch has not been used on some prototypes, but it is a desirable addition for maintaining stability of components except while actively driving a nail. Latch flap 66 moves through a small angle on latch hinge 67, and is pressed outward by a small compression spring (not shown) in a recess in hammer head 10 behind it. When the feeder arm 53 has risen far enough, which is a small distance, latch catch 65 will lose contact with latch flap 66, and feeder arm 53 will be free to move towards the rear. Feeder arm 53 moves towards the rear because it is pulled that way by toggle arm 100. When the nailing cycle is finished (nail driven) feeder arm 53 is free to move because toggle arm 100 is free because roller 104 has cleared the timing flap. At that time, spring 58 will pull the feeder arm 53 forward to its rest position, which is forward. When latch catch 65 meets latch flap 66, the latter moves inward to hammer head 10 on its hinge 67 because the leading surfaces 68, 69 of latch catch 65 and latch flap 66 are bevelled. When feeder arm 53 is latched, the nail gate 31 will indirectly be latched, because of its connection by means of gate link 35. All the actions described in this paragraph are mirrored by components on the other side of the nailer. FIG. 8 shows spring 58 as a continuous spring wrapped around hammer head 10, while an alternative embodiment shown in FIG. 1, comprises two springs fastened to a bar that is fastened to hammer head 10. Either embodiment is acceptable, as is any spring anywhere that causes the feeder arm 53 to move fully forward to its rest position.

In FIG. 8, when the feeder arm 53 moves rearward, it pulls on the gate link 35 which pulls on nail gate 31 and causes nail gate 31 to rotate, exposing the nail 80 and releasing it from the captivity created by fact that the nail head 81 could not pass if right nail gate 31 and left nail gate 30 were not open. A similar gate link is connected to nail gate 30 on the left side of the nailer. That exposing of nail 80 will be synchronized, as explained below, with the contact of the feed body 33 with the roof, so that the nail 80 becomes free to travel into the roof under the force of hammer head 10 while vertical link 50, the canister 20, and associated parts are moving freely and not impeding the advance of the hammer head 10.

FIG. 9 shows the nailer from the left side. In almost every respect, the nailer is symmetrical about its mid-plane through handle and hammer head 10. One small asymmetry is apparent in the nail gates 30, 31. The left nail gate 30 is cut slightly lower in part to create notch 36 to allow passage of the lower wire 85 that is attached to the nail 80. The upper wire 84 passes over the top of the nail gate 30. A coil of nails consists of many nails connected together by two or more thin wires to form a continuous belt of nails, and is a standard commodity in the construction industry. When the nail 80 begins to move, the upper wire 84 is cut, or broken from its attachment to the nail 80, by its contact with the top of the left nail gate 30. At the same time, the lower wire 85 is cut or broken from its attachment to the nail 80 by its contact with the top of the notch 36. The cutting function may be facilitated by making the upper end of the nail gates 30, 31 in the shape of a knife or cutting blade, but the sharp edge of a right angle at the top of the nail gates 30, 31 has been found generally adequate. Often, what occurs is not a cut but a breaking of the weld where the wire is fastened to the nail. The nail is then free to descend into the roof, often carrying with it an attached fragment of one or both of the wires. Both nail gates 30, 31, are shorter than would cause then to touch the head of the nail, so that the nail 80 can begin to move a small distance under the force of the hammer head 10 before the nail gates 30, 31 have fully opened. The touch guide 77 is connected to the hammer head 10 by screws, and stood off slightly from the hammer head 10 by a set of springs, not visible, in the gap 18. Those springs cushion the impact on the hammer head 10 when the nail 80 is fully driven into the roof.

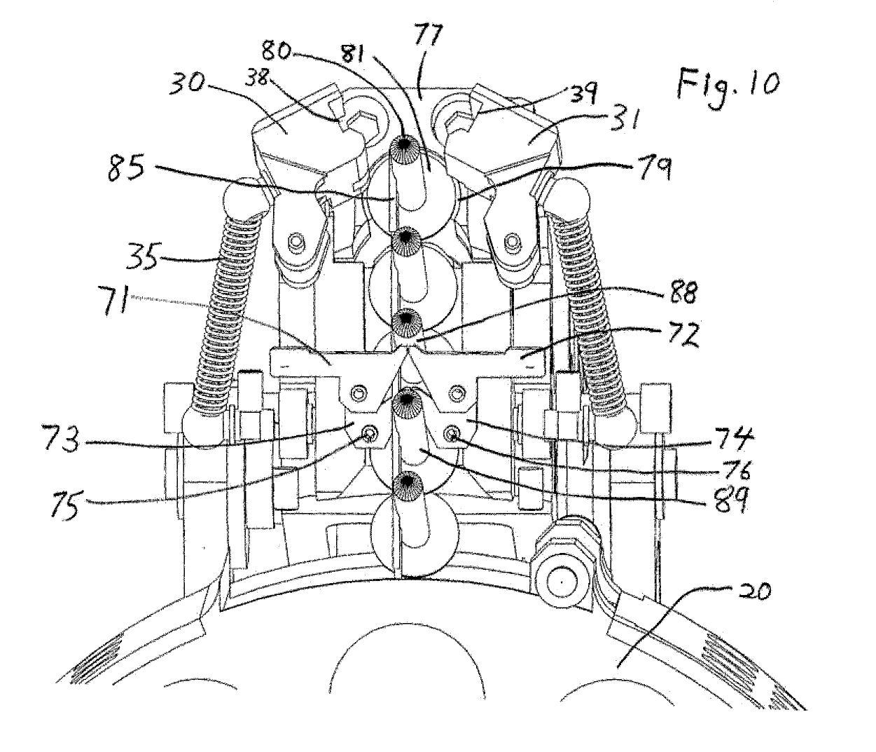

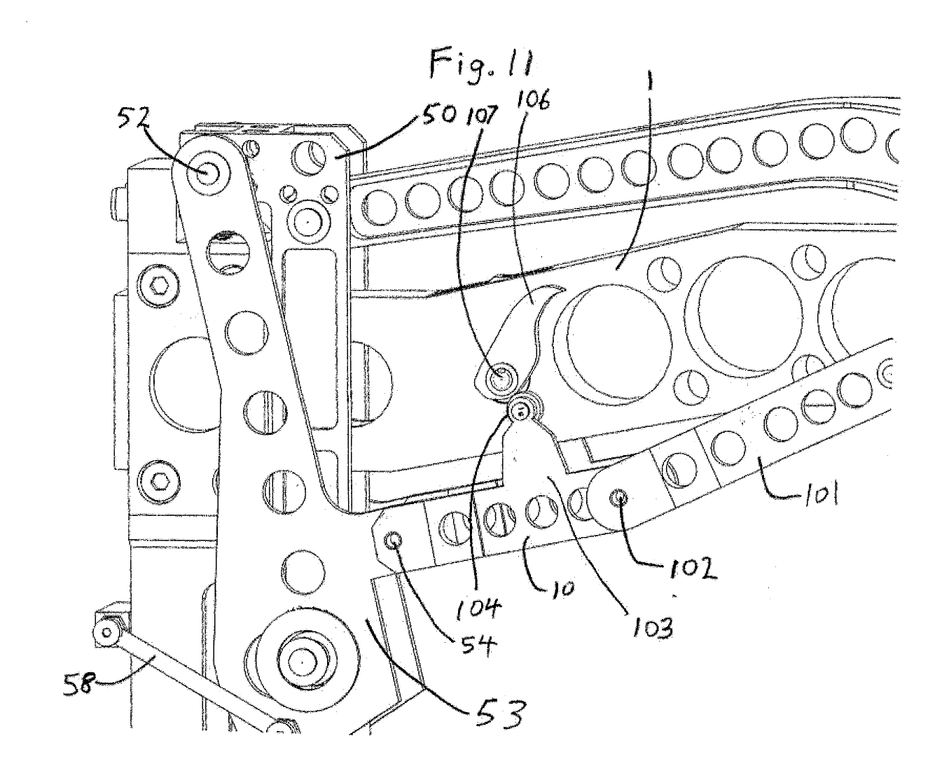

FIG. 10 shows more details of nail gates 30, 31 and the feeding mechanism, seen in perspective from below, at the moment when the nail 80 is just about to be driven into the roof. The two nail gates 30, 31 are open, having been pulled open by gate link 35 and its counterpart on the opposite side. When the two nail gates 30, 31 are closed, channels 38, 39 in them confine the ready-to-be-driven nail 80 (but not nail head 81) in a small space, without necessarily touching the nail. Five nails are shown, linked together by a pair of wires of which lower wire 85 is visible. Many more nails, not shown, would be connected to the same wire inside the canister 20. Nail 88 is prevented from moving backwards towards the canister 20 by a pair of keeping latches 71, 72. Nail 88 was, slightly earlier in the nailing cycle, pushed to the position now shown by a pair of feeding latches 73, 74. The feeding latches are moved by feeder arm 53 and its counterpart on the opposite side, which are not shown in FIG. 10 but feeder arm 53 is shown in FIG. 1. The two feeder arms are connected to feeding latches 73, 74 by hinge joints 75, 76. Just before the end of the nailing cycle, after nail 80 is gone because it has been driven into the roof, the feeder arms will have pulled back so that feeding latches 73, 74 are pulled back and are behind nail 89, so that they both have closed and are ready to push on nail 89. When the feeder arms move forward, feeding latches 73, 74 jointly push nail 89 slightly farther forward than the position held by nail 88 in FIG. 10. Next, keeping latches 71, 72 will close behind that nail and that nail will slip back that slightly extra distance forward until it touches keeping latches 71, 72 which will have closed behind that nail under the influence of a small torsion spring (not visible) in a manner well known in the art. To avoid conflict between the latches, keeping latches 71, 72 are mounted lower than feeding latches 73, 74. The nail head 81 is guided to the correct position by touch guide 77, which incorporates a cavity 79 that is open on the rear side where the nail head 81 enters and curved on the front side to conform to the curve of nail head 81. The hammer face 13 in FIG. 3, not shown here, passes through the cavity 79 in contact with nail head 81 and drives nail 80 into the roof

FIG. 11 shows the jointed toggle bar on the near side of the handle 1. It has a front section 100 and rear section 101, with a hinge joint 102 in the approximate middle. On the front section 100 there is a standoff 103 on which is mounted a small roller 104. The front section 100 is hingedly joined to the feeder arm 53 at hinge joint 54. When the feeder arm 53 is caused to move upwards by the lifting of the vertical link 50 to which it is attached at hinge joint 52, it is also caused to rotate a small amount about hinge link 52 with the lower portion moving rearward, because of the dogleg shape of the near-side arm (not visible). The toggle arm 100 must follow. By moving rearward, the toggle arm is forced to bend at the hinge joint 102. The roller 104 will then rise and lift the delay flap 106 by rotating it about pivot point 107. As the lifting of toggle section 100 continues, eventually the roller 104 will clear the delay flap 106 at the top and then seek to return down the top side of the delay flap 106 to the rest position of roller 104. The rotation of the delay flap 106 about pivot point 107 is limited by an angular limiter (not visible in FIG. 11). In one embodiment, the angular limiter is a bar in a cavity in the handle 1 which is firmly fastened to the delay flap 106 by an axle forming pivot point 107. That bar is limited by the sides of the cavity, so the axle is limited in rotation and the delay flap 106 is correspondingly limited in its rotation and will return to a rest position under the influence of a torsion spring. Other means of limiting the movement of the delay flap would be well known in the mechanical art. In an alternative embodiment, the delay flap 106 may be replaced by an appropriately shaped cam immovably fixed to the handle 1.

The roller 104 rises past the point where it is free of the delay flap 106, and the delay flap falls back to its original position, determined as explained in the immediately preceding paragraph. After the canister 20 and system of arms have risen as far as they need to go, at which point the nail will be fully driven into the roof, the canister and system of arms will begin to fall back under gravity, or possibly assisted by a spring. The roller 104 then rides along the top of the delay flap 106, which forces the toggle arm to remain bent. As long as the toggle aim retains its bent position, the feeder arm 53 cannot return to its rest position, but it can continue to move downwards. That explains the name “delay flap”. Just before the canister has moved all the way down to its rest position, the roller 104 will run off the delay flap 106, thereby freeing the toggle arm to return to its straight position. The toggle arm 100 is pulled into its straight position by the feeder arm 53 which is pulled to its rest position by the spring 58 which is connected to both the near-side feeder arm 53 and the far-side feeder arm. As explained elsewhere, that movement of the feeder arm 53 in returning to its rest position, which is almost instantaneous as soon as the roller 104 has lost contact with the delay flap 106, is used to advance the next nail into position to be driven, and also to close the nail gates so that the advanced nail will be held in position.

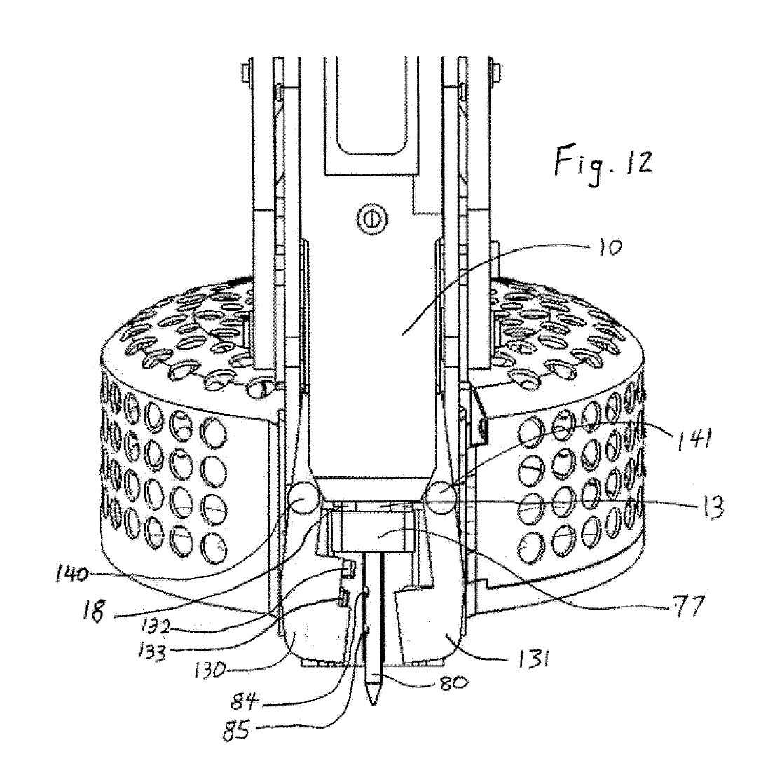

FIG. 12 shows an alternative embodiment of the nail gates. In this version, nail gates 130, 131 swing open sideways, instead of to the front. They are hinged on hinges 140, 141 respectively. The sideways opening motion of nail gates 130, 131 is caused as the hammer head 10 moves downward by a cam profile (not shown) on the rear of the hammer head 10. Torsion springs oppose the cam force, so that when the cam moves upward near the end of the nailing cycle, the nail gates 130, 131 are pressed closed by those springs. In FIG. 12, the nail 80 has been partly driven by hammer face 13 which is partly visible in gap 18 behind touch guide 77. In this view, the upper wire 84 and the lower wire 85 have been cut by the cutting bars 132 and 133, respectively, which are small projections with square corners forming part of the left nail gate 130.

While the preferred embodiments of the invention have been particularly described in the specification and illustrated in the drawings, and some alternatives have been disclosed, it should be understood that the invention is not so limited. Many modifications, equivalents and adaptations of the invention, and mechanical means to achieve movements and functions of the invention, will become apparent to those skilled in the art without departing from the spirit and scope of the invention as defined in the appended claims.

What is claimed is:

1. A nailer comprising:
a handle suitable for gripping by hand in a manner suitable for swinging the nailer like a hammer;
a hammer head fixed to said handle;
a set of arms hingedly movable in planes parallel to the plane through the long axes of both said hammer head and said handle so that the four hinge points of said set of arms define a flexible parallelogram;
a feed body attached to said set of arms;
a canister attached to said feed body, said canister adapted to contain a coil of nails;
means to advance said nails one at a time through said feed body to the position of being a ready nail directly below said hammer head after said hammer head has finished driving a prior nail; and
means to hold said ready nail in place until said hammer head has begun to drive said ready nail out of said nailer, and then to cease holding said ready nail.

2. A nailer as recited in claim 1, in which said means to hold said ready nail in place comprise a nail gate that swings away from said ready nail, said nail gate comprising a channel that fits partly around said ready nail.

3. A nailer as recited in claim 2, in which said nail gate comprises two halves, a left nail gate and a right nail gate that simultaneously swing away from said ready nail.

4. A nailer as recited in claim 2, further comprising means to cut at least one of the wires between said ready nail and the rest of said coil of nails when said ready nail begins to move as it is driven out of said nailer.

5. A nailer as recited in claim 4, in which said means to cut at least one of the wires comprise a sharp edge that is an integral part of said nail gate.

6. A nailer as recited in claim 1, in which said set of arms comprises a upper arm and a pair of lower arms on each side of said handle, each arm hingedly connected to said handle near the grip end of said handle, and all arms connected by a link near said hammer head.

7. A nailer as recited in claim 3, in which said nail gate is held open until a roller linked to said nail gate has circumscribed a delay flap.

8. A nailer comprising
a hammer head having a hammer face adapted to push nails, and having a top end at the point furthest from said hammer face;
a handle that is bent in two places to form a upper portion offset from a lower portion by a relatively short portion joining them, with said upper portion connected to said hammer head at a joining point near said top end, and the long axis of said lower portion in a line passing through said hammer head between said joining point and said hammer face; and
a container adapted to hold a coil of nails, said container movably connected to said handle so as to occupy the space defined on one side by said upper portion, on a second side by said relatively short portion or an axis extending therefrom, and on a third side by said hammer head or an axis extending therefrom.

9. A nailer comprising
a hammer head;
a handle;
a set of arms defining a flexible parallelogram hingedly connected to said handle at two points so that the link defining the side of said parallelogram furthest from said two points moves independently of said handle;
a container attached to said link, said container adapted to hold a coil of nails; and
means to advance said coil of nails by the distance between adjacent nails, thereby moving a ready nail into position ready to be struck by said hammer head.

10. A nailer as recited in claim 9, in which said means to advance said coil of nails comprises
a pair of feeding latches to jointly push on a nail in said coil and then to fall back by pivoting so as to slide past that nail and return to a position ready to push another nail;
a pair of keeping latches to prevent said coil of nails from retreating after having been advanced by said feeding latches, by pivoting so as to allow a nail to advance past said keeping latches and then closing behind that nail and holding that nail from retreating.

11. A nailer as recited in claim 10, in which said means to advance said coil of nails farther comprises at least one feeder arm connected to said pair of feeding latches so as to open said pair of feeding latches when said ready nail is about to be driven, and close them when said ready nail has been driven out of the nailer by said hammer head.

12. A nailer as recited in claim 11, in which said feeder arm is prevented from closing said feeding latches until a roller connected to said feeder arm has circumscribed a delay flap.
